(19) United States
(12) Patent Application Publication
(10) Pub. No.: US 2024/0017630 A1
(43) Pub. Date: Jan. 18, 2024

(54) POWERTRAIN, CHARGING CONTROL METHOD, AND ELECTRIC VEHICLE

(71) Applicant: Huawei Digital Power Technologies Co., Ltd., Shenzhen (CN)

(72) Inventors: Ying LI, Xi’an (CN); Xian LUO, Shanghai (CN)

(73) Assignee: Huawei Digital Power Technologies Co., Ltd., Shenzhen (CN)

(21) Appl. No.: 18/352,401

(22) Filed: Jul. 14, 2023

(30) Foreign Application Priority Data
Jul. 14, 2022 (CN) 202210827900.8

(51) Int. Cl. B60L 53/24; B60L 50/60

(52) U.S. Cl. CPC B60L 53/24; B60L 50/60

(57) ABSTRACT

A powertrain, a charging control method, and an electric vehicle. The powertrain includes a motor control unit and a motor. The motor control unit includes three bridge arms and a controller. A first end of a direct current power supply is coupled to one end of each bridge arm and a first end of the power battery. A second end of the power battery is coupled to the other end of each bridge arm. A midpoint of each bridge arm is coupled to one end of a motor winding. The other end of each motor winding is coupled to a second end of the direct current power supply. Two bridge arms of each bridge arm are turned on or off based on a first PWM signal and a second PWM signal. The first PWM signal and the second PWM signal are interleaved.

### CROSS-REFERENCE TO RELATED APPLICATION

This application claims priority to Chinese Patent Application No. 202210827900.8, filed on Jul. 14, 2022, which is hereby incorporated by reference in its entirety.

### TECHNICAL FIELD

The embodiments relate to the field of new energy vehicle technologies and to a powertrain, a charging control method, and an electric vehicle.

### BACKGROUND

Output voltages of some charging piles on an existing market range from 220 V to 500 V. To resolve problems related to slow charging speeds of an electric vehicle, a voltage of a power battery equipped on the current electric vehicle is high, for example, 600 V to 800 V. Therefore, when the voltage of the power battery on the electric vehicle is 600 V, a charging pile that can only output a voltage ranging from 220 V to 500 V cannot charge the electric vehicle. Therefore, to adapt to the some charging piles on the existing market, a bridge arm and a motor winding used to drive a motor in the electric vehicle can be reused, to increase the voltages output by the charging piles, and further provide increased voltages to the power battery. In this case, how to control turn-no or turn-off of the bridge arm is a key research issue at present.

### SUMMARY

The embodiments include a powertrain, a charging control method, and an electric vehicle, which can ensure that heat generated by magnetic steel in a motor falls within a safe range, and reduce a ripple of an output current of the powertrain.

According to a first aspect, an embodiment provides a powertrain. The powertrain is disposed between a direct current power supply and a power battery, the powertrain includes a motor control unit (MCU) and a motor, the MCU includes three bridge arms and a controller, and the motor includes three motor windings corresponding to the three bridge arms. In an implementation, a first end of the direct current power supply is coupled to one end of each of the three bridge arms and a first end of the power battery, and a second end of the power battery is coupled to the other end of each bridge arm. A midpoint of each bridge arm is coupled to one end of a motor winding corresponding to each bridge arm, and the other end of each of the three motor windings is coupled to a second end of the direct current power supply. The three bridge arms include a first bridge arm and a second bridge arm. The first bridge arm may be turned on or off based on a first pulse width modulation (PWM) signal sent by the controller, and the second bridge arm may be turned on or off based on a second PWM signal sent by the controller. The first PWM signal and the second PWM signal are interleaved, that is, a rising edge of the second PWM signal lags behind a first preset time period relative to a rising edge of the first PWM signal, or a falling edge of the second PWM signal lags behind a second preset time period relative to a falling edge of the first PWM signal. In the embodiment, the first PWM signal and the second PWM signal are controlled to be interleaved, to balance the amount of heat generated by magnetic steel in the motor and a size of a ripple of an output current of the powertrain, thereby not only ensuring that the heat generated by the magnetic steel in the motor falls within a safe range, but also reducing the ripple of the output current of the powertrain.

With reference to the first aspect, in a first possible implementation, the three bridge arms further include a third bridge arm. The third bridge arm may be turned on or off based on a third PWM signal. A rising edge of the third PWM signal lags behind a third preset time period relative to the rising edge of the second PWM signal, or a falling edge of the third PWM signal lags behind a fourth preset time period relative to the falling edge of the second PWM signal. Three-phase interleaving is implemented in the embodiment, that is, the three bridge arms are not turned on or off simultaneously. According to the embodiment, it can also be ensured that heat generated by magnetic steel in the motor falls within a safe range, and a ripple of an output current of the powertrain is reduced.

With reference to the first possible implementation of the first aspect, in a second possible implementation, a time period of the first PWM signal is T, and the first preset time period and the third preset time period are T/3, or the second preset time period and the fourth preset time period are T/3. The control manner of three-phase interleaving by 120° according to the embodiment is more in accordance with a control habit of the motor, which can also ensure that heat generated by magnetic steel in the motor falls within a safe range, and reduce a ripple of an output current of the powertrain.

With reference to the first aspect, in a third possible implementation, the three bridge arms further include a third bridge arm. The third bridge arm may be turned on or off based on a third PWM signal. A rising edge of the third PWM signal and the rising edge of the first PWM signal appear simultaneously, and a falling edge of the third PWM signal and the falling edge of the first PWM signal appear simultaneously.

With reference to the third possible implementation of the first aspect, in a fourth possible implementation, a time period of the first PWM signal is T, and the first preset time period is T/2, or the second preset time period is T/2.

With reference to any one of the possible implementations of the first aspect, in a fifth possible implementation, the first PWM signal, the second PWM signal, and the third PWM signal have a same time period and duty ratio.

With reference to the first aspect or any one of the possible implementations of the first aspect, in a sixth possible implementation, the powertrain further includes a first switching switch and a second switching switch. One end of the first switching switch is coupled to a midpoint of any of the three bridge arms.

In an embodiment where the other end of each of the three motor windings is coupled to a second end of the direct current power supply, the embodiment can include: the other end of each of the three motor windings is coupled to one end of the second switching switch, and the other end of the second switching switch and the other end of first switching switch are coupled to the second end of the direct current power supply.

With reference to the sixth possible implementation of the first aspect, in a seventh possible implementation, when a difference between a voltage of the power battery and a voltage of the direct current power supply is less than a first preset threshold, the first switching switch is turned off, and the second switching switch is turned on.

With reference to the sixth possible implementation of the first aspect, in an eighth possible implementation, when a difference between a voltage of the power battery and a voltage of the direct current power supply is greater than or equal to a first preset threshold, the first switching switch is turned on, and the second switching switch is turned off.

That the first bridge arm is turned on or off based on a first PWM signal, and the second bridge arm is turned on or off based on a second PWM signal is:
other two bridge arms in the three bridge arms other than the bridge arm coupled to the first switching switch are respectively turned on or off based on a fourth PWM signal and a fifth PWM signal.

With reference to the sixth possible implementation of the first aspect, in a ninth possible implementation, the powertrain further includes an inductor. In an embodiment where the other end of the second switching switch and the other end of the first switching switch are coupled to the second end of the direct current power supply, the embodiment can include: the other end of the second switching switch and the other end of the first switching switch are coupled to one end of the inductor, and the other end of the inductor is coupled to the second end of the direct current power supply.

According to a second aspect, an embodiment provides a charging control method. The charging control method is applied to a powertrain, and the powertrain includes an MCU and a motor. The MCU includes three bridge arms and a controller, and the motor includes three motor windings corresponding to the three bridge arms. In an implementation, a first end of the direct current power supply is coupled to one end of each of the three bridge arms and a first end of a power battery, and a second end of the power battery is coupled to the other end of each bridge arm. A midpoint of each bridge arm is coupled to one end of a motor winding corresponding to each bridge arm, and the other end of each of the three motor windings is coupled to a second end of the direct current power supply. The three bridge arms include a first bridge arm and a second bridge arm.

The charging control method is: sending, by the controller, a first PWM signal to the first bridge arm, and sending a second PWM signal to the second bridge arm. The first PWM signal and the second PWM signal are interleaved, that is, a rising edge of the second PWM signal lags behind a first preset time period relative to a rising edge of the first PWM signal, or a falling edge of the second PWM signal lags behind a second preset time period relative to a falling edge of the first PWM signal.

With reference to the second aspect, in a first possible implementation, the three bridge arms further include a third bridge arm. The charging control method further includes: sending, by the controller, a third PWM signal to the third bridge arm. A rising edge of the third PWM signal lags behind a third preset time period relative to the rising edge of the second PWM signal, or a falling edge of the third PWM signal lags behind a fourth preset time period relative to the falling edge of the second PWM signal.

With reference to the first possible implementation of the second aspect, in a second possible implementation, a time period of the first PWM signal is T, and the first preset time period and the third preset time period are T/3, or the second preset time period and the fourth preset time period are T/3.

With reference to the second aspect, in a third possible implementation, the three bridge arms further include a third bridge arm. The charging control method further includes: sending, by the controller, a third PWM signal to the third bridge arm. A rising edge of the third PWM signal and the rising edge of the first PWM signal appear simultaneously, and a falling edge of the third PWM signal and the falling edge of the first PWM signal appear simultaneously.

With reference to the third possible implementation of the second aspect, in a fourth possible implementation, a time period of the first PWM signal is T, and the first preset time period is T/2, or the second preset time period is T/2.

With reference to any one of the possible implementations of the second aspect, in a fifth possible implementation, the first PWM signal, the second PWM signal, and the third PWM signal have a same time period and duty ratio.

With reference to the second aspect or any one of the possible implementations of the second aspect, in a sixth possible implementation, the powertrain further includes a first switching switch and a second switching switch.

The charging control method further includes:
when a difference between a voltage of the power battery and a voltage of the direct current power supply is less than a first preset threshold, controlling, by the controller, the first switching switch to be turned off, and controlling the second switching switch to be turned on. One end of the first switching switch is coupled to a midpoint of any of the three bridge arms, and the other end of the first switching switch is coupled to the second end of the direct current power supply. One end of the second switching switch is coupled to the other end of each of the three motor windings, and the other end of the second switching switch is coupled to the second end of the direct current power supply.

With reference to the sixth possible implementation of the second aspect, in an eighth possible implementation, when a difference between a voltage of the power battery and a voltage power supply is greater than or equal to a first preset threshold, the controller controls the first switching switch to be turned on, and controls the second switching switch to be turned off. The controller further sends a fourth PWM signal and a fifth PWM signal respectively to other two bridge arms in the three bridge arms other than the bridge arm coupled to the first switching switch.

According to a third aspect, an embodiment provides an electric vehicle. The electric vehicle includes a power battery and the powertrain with reference to the first aspect or any of the possible implementations of the first aspect.

It should be understood that mutual reference may be made between implementations and beneficial effects of the foregoing aspects in the embodiments.

### BRIEF DESCRIPTION OF DRAWINGS

FIG. 1 is a schematic diagram of a structure of a powertrain according to an embodiment;

FIG. 2 is a schematic diagram of a charging scenario of an electric vehicle according to an embodiment;

FIG. 3 is a schematic diagram of a structure of a powertrain according to an embodiment;

FIG. 4 is a schematic diagram of a waveform according to an embodiment;

FIG. 5 is a schematic diagram of another waveform according to an embodiment;

FIG. 6 is a schematic diagram of another waveform according to an embodiment;

FIG. 7A is a schematic diagram of a current ripple according to an embodiment;

FIG. 7B is another schematic diagram of a current ripple according to an embodiment;

FIG. 8 is a schematic diagram of another waveform according to an embodiment;

FIG. 9 is a schematic diagram of another structure of a powertrain according to an embodiment;

FIG. 10 is a schematic diagram of another structure of a powertrain according to an embodiment;

FIG. 11A is a schematic diagram of a circuit status of a powertrain according to an embodiment;

FIG. 11B is another schematic diagram of a circuit status of a powertrain according to an embodiment;

FIG. 11C is another schematic diagram of a circuit status of a powertrain according to an embodiment;

FIG. 11D is another schematic diagram of a circuit status of a powertrain according to an embodiment;

FIG. 11E is another schematic diagram of a circuit status of a powertrain according to an embodiment;

FIG. 11F is another schematic diagram of a circuit status of a powertrain according to an embodiment;

FIG. 12A is a schematic diagram of another circuit status of a powertrain according to an embodiment;

FIG. 12B is another schematic diagram of another circuit status of a powertrain according to an embodiment;

FIG. 13A is a schematic diagram of another circuit status of a powertrain according to an embodiment;

FIG. 13B is another schematic diagram of another circuit status of a powertrain according to an embodiment;

FIG. 14A is a schematic diagram of another circuit status of a powertrain according to an embodiment; and

FIG. 14B is a schematic diagram of another circuit status of a powertrain according to an embodiment.

### DETAILED DESCRIPTION OF EMBODIMENTS

The following clearly describes the solutions with reference to the accompanying drawings and embodiments. It is clear that the described embodiments are some, but not all, of the possible embodiments. Any other embodiments obtained by a person of ordinary skill in the art based on the embodiments without creative efforts shall fall within the scope of embodiments herein.

The solutions of the embodiments are further described below in detail with reference to the accompanying drawings.

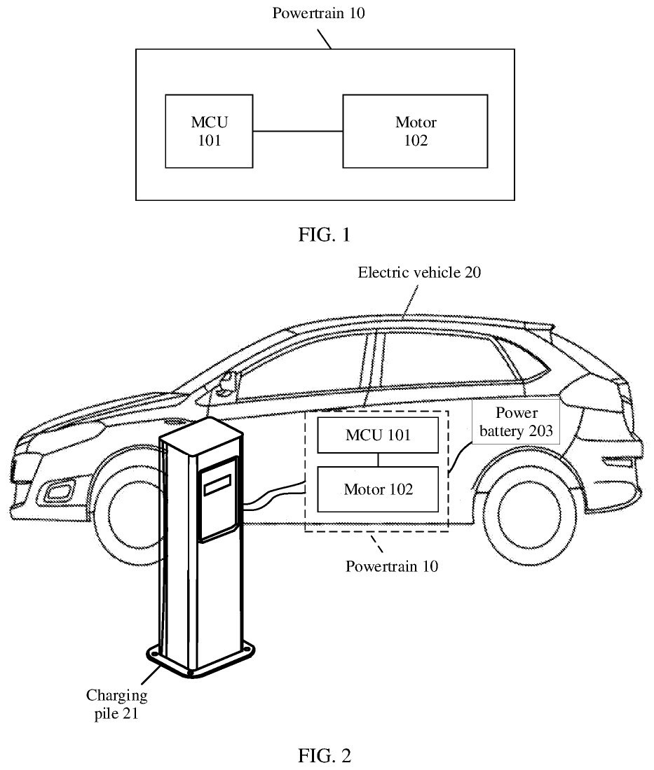

FIG. 1 is a schematic diagram of a structure of a powertrain according to an embodiment. As shown in FIG. 1, the powertrain 10 includes a motor control unit (MCU) 101 and a motor 102.

The MCU 101 includes three bridge arms and a controller. The controller may send pulse width modulation (PWM) signals to the three bridge arms. The three bridge arms may be turned on or off respectively based on the received PWM signals.

For example, the controller may be, for example, a central processing unit (CPU), another general purpose processor, a digital signal processor (DSP), an application-specific integrated circuit (ASIC), a field programmable gate array (FPGA) or another programmable logic device, a discrete gate or a transistor logic device, or a discrete hardware component.

In some possible implementations, the three bridge arms and the controller are welded in a body of a same printed circuit board (PCB) or bodies of different PCBs. The PCB may be disposed inside a hardware box. The hardware box is disposed on the top of the motor.

The powertrain 10 may be integrated as a whole and disposed in an electric vehicle. In this case, a schematic diagram of a charging scenario of an electric vehicle is shown in FIG. 2. As shown in FIG. 2, an electric vehicle 20 includes a power battery 203 and the powertrain 10 shown in FIG. 1.

The power battery 203 establishes a connection to a direct current power supply by using the powertrain 10. In FIG. 2, an example in which the direct current power supply is a charging pile 21 is used. In some other possible implementations, the direct current power supply may be another electric vehicle (not shown in the figure).

The following describes a structure of the powertrain provided in the embodiments with reference to the accompanying drawings.

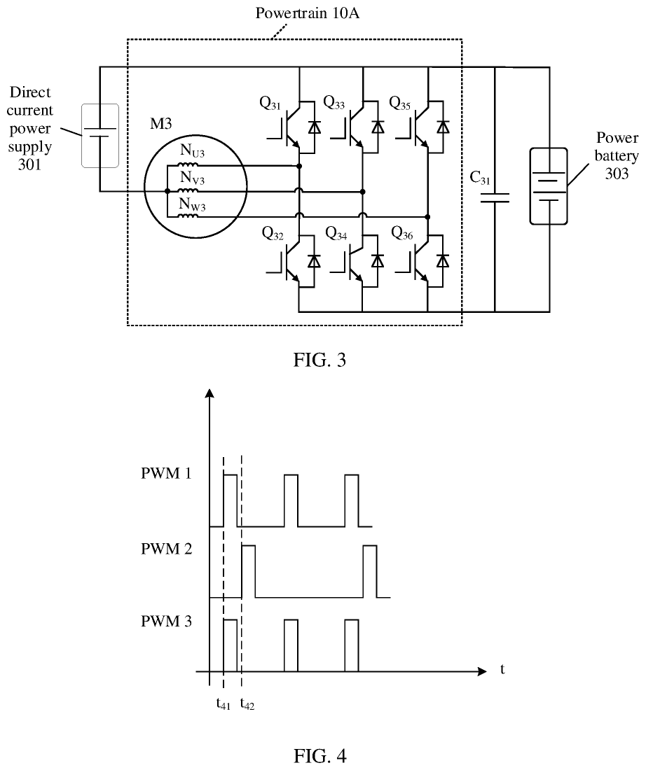

In some possible implementations, FIG. 3 is a schematic diagram of a structure of a powertrain according to an embodiment. As shown in FIG. 3, a powertrain 10A is disposed between a direct current power supply 301 and a power battery 303. The powertrain 10A includes an MCU and a motor M3.

The MCU includes three bridge arms and a controller (not shown in the figure). The three bridge arms include a first bridge arm, a second bridge arm, and a third bridge arm. It should be noted that each bridge arm may include two switch units connected in series. A switch unit can include at least one switch connected in series or in parallel. In practice, the switch unit can select, based on a voltage and a current in a power supply module, a plurality of switches connected in series or in parallel. The switch may be an insulated gate bipolar transistor (IGBT) and an anti-parallel diode of the IGBT, or a metal-oxide-semiconductor field-effect transistor (MOSFET). In general, types and quantities of switches in the switch unit are not limited in the embodiments.

A example in which a switch included in a bridge arm is when the IGBT and the anti-parallel diode of the IGBT is used. As shown in FIG. 3, the first bridge arm includes a switch tube Q₃₁ and a switch tube Q₃₂ connected in series with the switch tube Q₃₁. The second bridge arm includes a switch tube Q₃₃ and a switch tube Q₃₄ connected in series with the switch tube Q₃₃. The third bridge arm includes a switch tube Q₃₅ and a switch tube Q₃₆ connected in series with the switch tube Q₃₅.

It should be noted that the first bridge arm, the second bridge arm, and the third bridge arm may be interchangeable. For example, the first bridge arm includes the switch tube Q₃₃ and the switch tube Q₃₄ connected in series with the switch tube Q₃₃. The second bridge arm includes the switch tube Q₃₅ and the switch tube Q₃₆ connected in series with the switch tube Q₃₅. The third bridge arm includes the switch tube Q₃₁ and the switch tube Q₃₂ connected in series with the switch tube Q₃₁.

In an implementation, a first end of the direct current power supply 301 is coupled to one end of each bridge arm and a first end of the power battery 303. In this case, as shown in FIG. 3, the first end of the direct current power supply 301 is a positive end, a second end of the direct current power supply 301 is a negative end, the first end of the power battery 303 is a positive end, and a second end of the power battery 303 is a negative end.

In this case, the positive end of the direct current power supply 301 is coupled to a collector of the switch tube Q₃₁, a collector of the switch tube Q₃₃, a collector of the switch tube Q₃₅, and the positive end of the power battery 303. The negative end of the power battery 303 is coupled to an emitter of the switch tube Q₃₂, an emitter of the switch tube Q₃₄, and an emitter of the switch tube Q₃₆.

It should be noted that the “coupling” is referred to direct or indirect connection. For example, that A is coupled to B may be that A is directly connected to B, or may be that A and B are indirectly connected by using one or more other electronic components. For example, A may be directly connected to C, and C is directly connected to B, so that A and B are connected by using C. For example, the direct current power supply 301 may be connected to the collector of the switch tube Q₃₁, the collector of the switch tube Q₃₃, the collector of the switch tube Q₃₅, and the positive end of the power battery 303 by using switches.

A midpoint of each bridge arm is coupled to one end of a motor winding corresponding to each bridge arm. The midpoint of each bridge arm is a series coupling point between two switch units connected in series. In this case, an emitter of the switch tube Q₃₁ and a collector of the switch tube Q₃₂ are coupled to one end of a motor winding NU₃, an emitter of the switch tube Q₃₃ and a collector of the switch tube Q₃₄ are coupled to one end of a motor winding N_{V3}, and an emitter of the switch tube Q₃₅ and a collector of the switch tube Q₃₆ are coupled to one end of a motor winding N_{W3}.

The other end of the motor winding N_{U3}, the other end of the motor winding N_{V3}, and the other end of the motor winding N_{W3} are coupled to the negative end of the direct current power supply 301.

Optionally, in some possible implementations, the first end of the direct current power supply may be the negative end, the second end of the direct current power supply may be the positive end, the first end of the power battery may be the negative end, and the second end of the power battery may be the positive end (not shown in the figure). In this case, the positive end of the direct current power supply is coupled to the other end of each motor winding, and the negative end of the direct current power supply is coupled to the other end of each bridge arm.

How to control the powertrain provided in this embodiment is used as an example for description below with reference to the accompanying drawings.

In some possible implementations, FIG. 4 is a schematic diagram of a waveform according to an embodiment. As shown in FIG. 4, the controller may send a PWM1 signal to the switch tube Q₃₁ and send a PWM2 signal to the switch tube Q₃₃. In this case, a rising edge of the PWM1 signal, for example, is at a t₄₁ moment, a rising edge of the PWM2 signal, for example, is at a t₄₂ moment. Therefore, interleaving of the PWM1 signal and the PWM2 signal is: the t₄₂ moment lags behind the t₄₁ moment for a first preset time period.

The first preset time period is preset. A length of the first preset time period is related to a size of a ripple of an output current of the powertrain and the amount of heat generated by magnetic steel in the motor. The setting of the first preset time period may be adjusted based on specific practical applications, that is, the length of the first preset time period is not limited in this embodiment.

Further, interleaving of the PWM1 signal and the PWM2 signal may alternatively be that a falling edge of the PWM1 signal and a falling edge of the PWM2 signal are staggered. For example, the falling edge of the PWM2 signal lags behind a second preset time period relative to the falling edge of the PWM1 signal. Similarly, the second preset time period is preset. A length of the second preset time period is related to a size of a ripple of an output current of the powertrain and the amount of heat generated by magnetic steel in the motor. The setting of the second preset time period may also be adjusted based on specific practical applications, that is, the length of the second preset time period is not limited in the embodiment.

It should be noted that in some practical applications, the rising edges or the falling edges of the PWM1 signal and the PWM2 signal may be set, that is, the first preset time period is preset or the second preset time period is preset, to implement interleaving of the PWM1 signal and the PWM2 signal. Alternatively, the rising edges and the falling edges of the PWM1 signal and the PWM2 signal may be set simultaneously, that is, the first preset time period and the second preset time period are preset, to implement interleaving of the PWM1 signal and the PWM2 signal.

For example, an example in which the controller sends a PWM3 signal to the switch tube Q₃₅ is used in FIG. 4. A rising edge of the PWM3 signal, for example, is at the t₄₁ moment, that is, the rising edge of the PWM3 signal and the rising edge of the PWM1 appear simultaneously.

It may be understood that the signals sent by the controller to two switch units in a same switch bridge arm are complementary. That is, a signal sent by the controller to the switch tube Q₃₂ and the PWM1 signal are complementary, a signal sent to the switch tube Q₃₄ and the PWM2 signal are complementary, and a signal sent to the switch tube Q₃₆ and the PWM3 signal are complementary. In this case, in this embodiment, the PWM1 signal controlling the switch tube Q₃₁ may be referred as a first PWM signal, and the PWM2 signal controlling the switch tube Q₃₃ may be referred to as a second PWM signal.

When the switch tube Q₃₁ and the switch tube Q₃₃ are turned on simultaneously, the motor winding N_{U3} and the motor winding N_{V3} are connected in parallel, so that the inductance in the powertrain is reduced, thereby increasing a ripple of an output current of the powertrain. In this embodiment, the controller controls the first PWM signal of the first bridge arm (that is, the switch tube Q₃₁) and the second PWM signal of the second bridge arm (that is, the switch tube Q₃₃) to be interleaved with each other, so that the switch tube Q₃₃ lags behind the switch tube Q₃₁ to be turned on, and then the motor winding N_{U3} and the motor winding N_{V3} in the powertrain are connected in parallel for less time, or even the motor winding N_{U3} and the motor winding N_{V3} are not connected in parallel. In this case, the inductance in the powertrain is larger than the inductance generated when the switch tube Q₃₁ and the switch tube Q₃₃ are turned on simultaneously, and the ripple of the output current of the powertrain is small.

In general, in this embodiment, a balance between the amount of heat generated by magnetic steel in the motor and a size of a ripple of an output current of the powertrain can not only ensure that the heat of the magnetic steel in the motor falls within a safe range, but also can reduce the ripple of the output current of the powertrain.

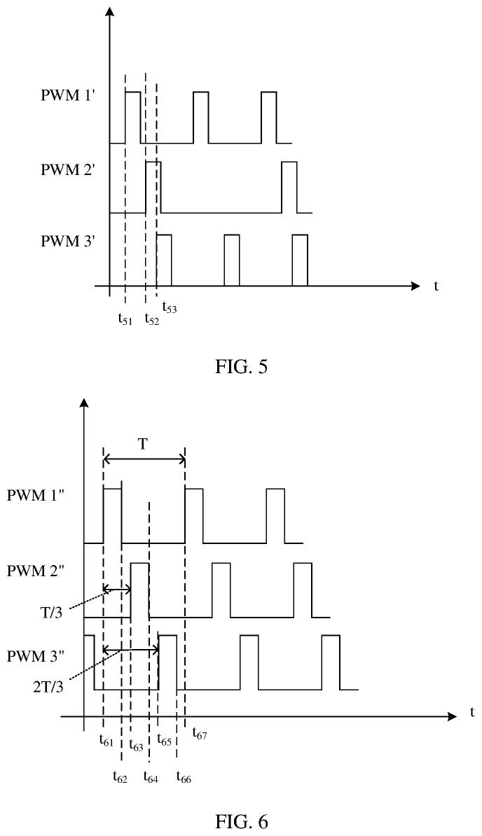

FIG. 5 is a schematic diagram of another waveform according to another embodiment. As shown in FIG. 5, the controller may send a [symbol] signal to the switch tube Q₃₁, send a [symbol] signal to the switch tube Q₃₃, and send a [symbol] signal to the switch tube Q₃₅. In this case, a rising edge of the [symbol] signal, for example, is at a t₅₁ moment, a rising edge of [symbol] signal for example, is at a t₅₂ moment, and a rising edge of [symbol] , for example, is at a t₅₃ moment.

That the [symbol] signal, the [symbol] signal, the [symbol] signal are interleaved with each other is: the t₅₂ moment lags behind the t₅₁ moment for a first preset time period, and the t₅₃ moment lags behind the t₅₂ moment for a third preset time period. The third preset time period is also preset. A length of the third preset time period is also related to a size of a ripple of an output current of the powertrain and the amount of heat generated by magnetic steel in the motor. The setting of the third preset time period may be adjusted based on specific practical applications, that is, the length of the third preset time period is not limited in this embodiment.

Also, that the [symbol] signal, the PWM2 signal, and the [symbol] signal are interleaved with each other may alternatively be: a falling edge of the [symbol] signal lags behind a second preset time period relative to a falling edge of the [symbol] signal, and a falling edge of the [symbol] signal lags behind a fourth preset time period relative to a falling edge of the [symbol] signal. Similarly, the fourth preset time period is preset. The fourth preset time period is related to a size of a ripple of an output current of the powertrain and the amount of heat generated by magnetic steel in the motor. The setting of the fourth preset time period may also be adjusted based on specific practical applications, that is, the length of the fourth preset time period is not limited in this embodiment.

It should be noted that in some practical applications, the rising edges or the falling edges of the [symbol] signal, the [symbol] signal, and the [symbol] signal may be set, that is, the first preset time period and the third preset time period are preset, to implement interleaving of the [symbol] signal, the [symbol] signal, and the [symbol] signal. Alternatively, the second preset time period and the fourth preset time period are preset, to implement interleaving of the [symbol] signal, the [symbol] signal, and the [symbol] signal. Alternatively, the rising edges and the falling edges of the [symbol] signal, the [symbol] signal, and the [symbol] signal may be set simultaneously, that is, the first preset time period, the second preset time period, the third preset time period, and the fourth preset time period are preset, to implement interleaving of the [symbol] signal, the [symbol] signal, and the [symbol] signal.

The schematic diagram of the waveform shown in this embodiment realizes three-phase interleaving, that is, switch tubes in the three bridge arms are not turned on simultaneously. For example, the switch tube Q₃₃ lags behind the switch tube Q₃₁ to be turned on, and the switch tube Q₃₅ lags behind the switch tube Q₃₃ to be turned on. Compared to controlling the three bridge arms by using the schematic diagram of the waveform shown in FIG. 4, the inductance of the powertrain obtained through controlling in this embodiment is larger, so that the ripple of the output current of the powertrain is smaller, but in this case, the amount of the heat generated by the magnetic steel of the motor is larger. In general, according to this embodiment, it can also be ensured that heat generated by magnetic steel in the motor falls within a safe range, and a ripple of an output current of the powertrain is reduced.

FIG. 6 is a schematic diagram of another waveform according to yet another embodiment. As shown in FIG. 6, the controller may send a [symbol] signal to the switch tube Q₃₁, send a [symbol] signal to the switch tube Q₃₃, and send a [symbol] signal to the switch tube Q₃₅. In this case, a rising edge of the [symbol] signal, for example, is at a t₆₁ moment, a corresponding falling edge is at a t₆₂ moment. A rising edge of the [symbol] signal, for example, is at a t₆₃ moment, and a corresponding falling edge is at a t₆₄ moment. A rising edge of the [symbol] signal, for example, is at a t₆₅ moment, and a corresponding falling edge is at a t₆₆ moment. A next rising edge of the [symbol] signal is at a t₆₇ moment. Therefore, a time period of the [symbol] signal is a time difference (for example, T) between the t₆₇ moment and the t₆₁ moment.

That the [symbol] signal, the [symbol] signal, and the [symbol] signal are interleaved with each other is: the t₆₃ moment lags behind the t₆₁ moment for a first preset time period, and the t₆₅ moment lags behind the t₆₃ moment for a third preset time period. Compared to the schematic diagram of the waveform shown in FIG. 5, in this embodiment, the first preset time period and the third preset time period are equal, and are T/3. In this case, the three bridge arms are three-phase interleaved by 120°.

Further, that the [symbol] signal, the [symbol] signal, and the [symbol] signal are interleaved with each other may alternatively be: the falling edge of the [symbol] signal lags behind a second preset time period relative to the falling edge of the [symbol] signal, and the falling edge of the [symbol] signal lags behind a fourth preset time period relative to the falling edge of the [symbol] signal. In this case, the second preset time period and the fourth preset time period are equal, and are T/3.

The schematic diagram of the waveform shown in this embodiment realizes three-phase interleaving by 120°, that is, switch tubes in the three bridge arms are not turned on simultaneously. For example, the turn-on of the switch tube Q₃₃ lags behind the turn-on of the switch tube Q₃₁ for T/3, and the turn-on of the switch tube Q₃₅ lags behind the turn-on of the switch tube Q₃₃ for T/3. Compared to controlling the three bridge arms by using the schematic diagram of the waveform shown in FIG. 5, the control manner of three-phase interleaving by 120° in this embodiment is more in accordance with a controlling habit of the motor, and the effects described in FIG. 5 may also be implemented in this embodiment.

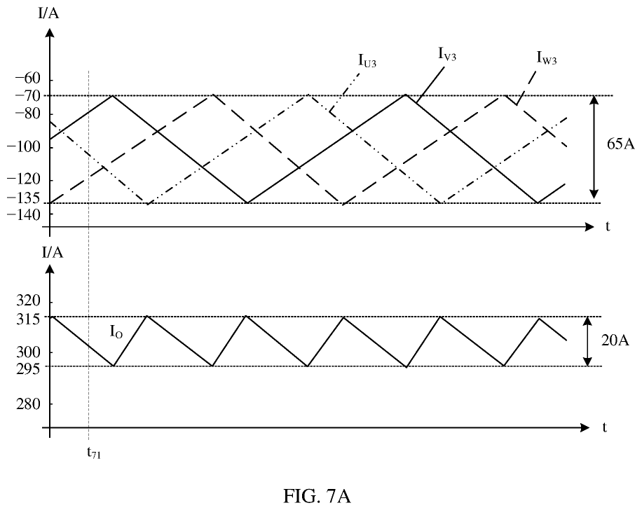

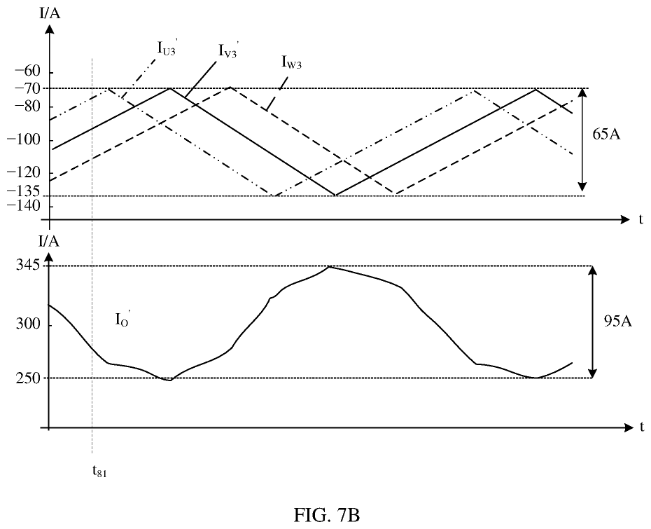

In this case, a schematic diagram of a ripple of an output current of the powertrain may refer to FIG. 7A. As shown in FIG. 7A, a current of the motor winding N_{U3} is I_{U3}, a current of the motor winding N_{V3} is I_{V3}, and a current of the motor winding N_{W3} is I_{W3}. In a case in which the three bridge arms are three-phase interleaved by 120°, the currents I_{U3}, I_{V3}, and I_{W3} are also interleaved by 120°. Therefore, at any t₇₁ moment, the output current I_{O} of the powertrain is a sum of the currents I_{U3}, I_{V3} and I_{W3}. For example, a ripple amplitude of a current of each motor winding is 65 A. A ripple amplitude of the output current I_{O} of the powertrain may be 20 A. It may be understood that it can be seen from the schematic diagram of a ripple shown in FIG. 7A that ripple currents of the three motor windings are interleaved. In this case, peak values of ripples of the motor windings may be staggered. For example, when a ripple current of the motor winding N_{U3} is large, a ripple current of the motor winding N_{V3} and a ripple current of the motor winding N_{W3} are small, so that a ripple of the output current of the powertrain is less than a ripple current of any motor winding.

Assuming that signals of the three bridge arms are synchronized, the currents I_{U3}, I_{V3} and I_{W3} are also synchronized, and peak values of ripples of the motor windings appear simultaneously, so that a ripple amplitude of the output current of the powertrain is 3*65=195 A. In this case, the ripple of the output current of the powertrain is large.

To describe an effect of the three-phase interleaved control manner with different angles on a size of the ripple of the output current of the powertrain, an embodiment further provides a schematic diagram of a ripple shown in FIG. 7B. In the schematic diagram of a current ripple shown in FIG. 7B, the controller controls the three bridge arms by using a control manner of three-phase interleaving by 60°, that is, the first preset time period and the third preset time period are equal, and are T/6. In this case, as shown in FIG. 7B, a current of the motor winding N_{U3} is [symbol] a current of the motor winding N_{V3} is [symbol] , and a current of the motor winding N_{W3} is [symbol] . Therefore, at any t₈₁ moment, an output current [symbol] of the powertrain is a sum of the currents [symbol] , [symbol] and [symbol] . For example, a ripple amplitude of a current of each motor winding is 65 A. A ripple amplitude of the output current [symbol] of the powertrain may be 95 A.

Optionally, in some possible implementations, periods of the [symbol] signal, the [symbol] signal, and the [symbol] signal are equal, that is, are all T. In addition, duty ratios of the [symbol] signal, the [symbol] signal, and the [symbol] signal are the same. By implementing this embodiment, the controller may generate control signals of the three bridge arms by using a same working frequency, and does not need to switch different frequencies to generate signals with different periods, which is easy to control.

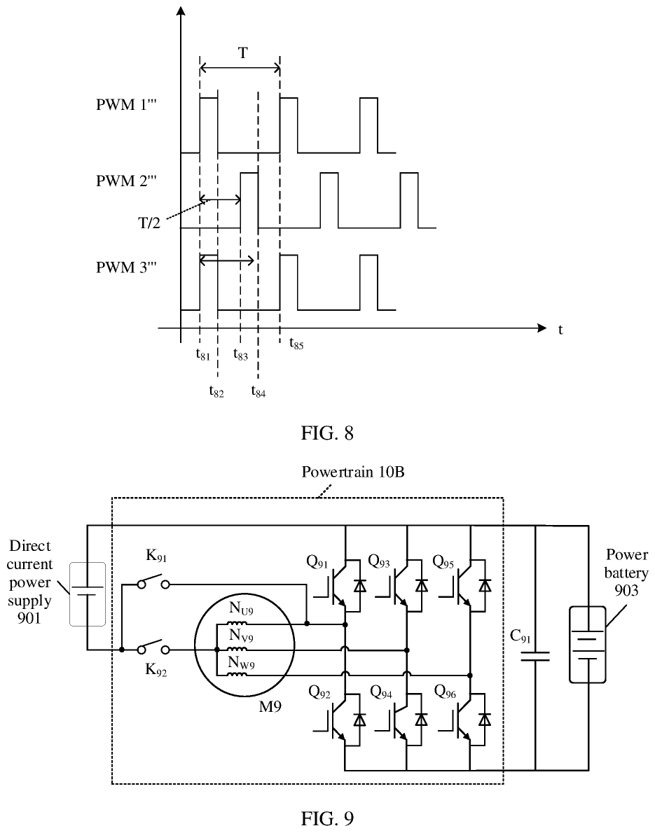

Optionally, in some possible implementations, FIG. 8 is a schematic diagram of another waveform according to an embodiment. As shown in FIG. 8, the controller may send a [symbol] signal to the switch tube Q₃₁, send a [symbol] signal to the switch tube Q₃₃, and send a [symbol] signal to the switch tube Q₃₅. In this case, a rising edge of the [symbol] signal, for example, is at a t₈₁ moment, a corresponding falling edge is at a t₈₂ moment. A rising edge of the [symbol] signal, for example, is at the t₈₁ moment, and a corresponding falling edge is at the t₈₂ moment. That is, the rising edge of the [symbol] signal and the rising edge of the [symbol] signal appear simultaneously, and the falling edge of the [symbol] signal and the falling edge of the [symbol] signal appear simultaneously. In this case, a time period of the [symbol] signal is a time difference (for example, T) between the t₈₂ moment and the t₈₁ moment.

A rising edge of the [symbol] signal, for example, is at a t₈₃ moment, and a corresponding falling edge is at a t₈₄ moment. It can be seen that the t₈₃ moment lags behind the t₈₁ moment for a first preset time period, and the first preset time period is T/2. In this case, two of the three bridge arms are interleaved by 180°.

The schematic diagram of the waveform shown in this embodiment realizes two-phase interleaving by 180°, that is, switch tubes in two bridge arms are not turned on simultaneously. For example, the switch tube Q₃₁ and the switch tube Q₃₃ are turned on simultaneously, and the switch tube Q₃₅ lags behind the switch tube Q₃₁ and the switch tube Q₃₃ for T/2 to be turned on. It is understood that, in the process of research and practice, when the controller controls the three bridge arms by using the schematic diagram of the waveform shown in FIG. 8, the amount of the heat generated by the magnetic steel of the motor is small.

Thus, each switch tube (for example, the switch tube Q₃₁, the switch tube Q₃₃, and the switch tube Q₃₅) in the three bridge arms is turned on when receiving a voltage in high level, and is turned off when receiving a voltage in low level. Therefore, each switch tube may be turned on or off based on the schematic diagram of the waveform shown in FIG. 4, FIG. 5, and FIG. 6, so that the powertrain forms different circuit statuses, thereby increasing the voltage of the direct current power supply 301, and further providing the increased voltage to the power battery 303.

It should be noted that the controller controls the switch tubes in the three bridge arms by using any schematic diagram of the waveform shown in FIG. 4 to FIG. 6, which should be understood as an example. The controller may further use another schematic diagram, provided that rising edges or falling edges of signals of switch tubes of any two of the three bridge arms are interleaved.

Optionally, in some possible implementations, FIG. 9 is a schematic diagram of another structure of a powertrain according to an embodiment. As shown in FIG. 9, a powertrain 10B is disposed between a direct current power supply 901 and a power battery 903. The powertrain 10B includes three bridge arms, a motor M9, a first switching switch K₉₁, and a second switching switch K₉₂.

An example in which a switch included in a bridge arm is an IGBT and an anti-parallel diode of the IGBT is used. As shown in FIG. 9, a first bridge arm includes a switch tube Q₉₁ and a switch tube Q₉₂ connected in series with the switch tube Q₉₁. A second bridge arm includes a switch tube Q₉₃ and a switch tube Q₉₄ connected in series with the switch tube Q₉₃. A third bridge arm includes a switch tube Q₉₅ and a switch tube Q₉₆ connected in series with Q₉₅.

It should be noted that the first bridge arm, the second bridge arm, and the third bridge arm may be interchangeable. For example, the first bridge arm includes the switch tube Q₉₃ and the switch tube Q₉₄ connected in series with the switch tube Q₉₃. The second bridge arm includes the switch tube Q₉₅ and the switch tube Q₉₆ connected in series with the switch tube Q₉₅. The third bridge arm includes the switch tube Q₉₁ and the switch tube Q₉₂ connected in series with the switch tube Q₉₁.

The first switching switch K₉₁ and the second switching switch K₉₂ may be a contactor, a relay, an IGBT, or a MOSFET.

A first end of the direct current power supply 901 is coupled to one end of each bridge arm and a first end of the power battery 903. In this case, the first end of the direct current power supply 901 shown in FIG. 9 is a positive end, and a second end of the direct current power supply 901 is a negative end. The first end of the power battery 903 is a positive end, and a second end of the power battery 903 is a negative end.

That is, the positive end of the direct current power supply 901 is coupled to a collector of the switch tube Q₉₁, a collector of the switch tube Q₉₃, a collector of the switch tube Q₉₅, and the positive end of the power battery 903. The negative end of the power battery 903 is coupled to an emitter of the switch tube Q₉₂, an emitter of the switch tube Q₉₄, and an emitter of the switch tube Q₉₆.

A midpoint of each bridge arm is coupled to one end of a motor winding corresponding to each bridge arm. The midpoint of each bridge arm is a series coupling point between two switch units connected in series. In this case, an emitter of the switch tube Q₉₁ and a collector of the switch tube Q₉₂ are coupled to one end of a motor winding N_{U9}, an emitter of the switch tube Q₉₃ and a collector of the switch tube Q₉₄ are coupled to one end of a motor winding N_{V9}, and an emitter of the switch tube Q₉₅ and a collector of the switch tube Q₉₆ are coupled to one end of a motor winding N_{W9}.

One end of the first switching switch K₉₁ is coupled to a midpoint of any of the three bridge arms. FIG. 9 uses an example in which one end of the first switching switch K₉₁ is coupled to the emitter of the switch tube Q₉₁ and the collector of the switch tube Q₉₂. Optionally, one end of the first switching switch K₉₁ may be coupled to the emitter of the switch tube Q₉₃ and the collector of the switch tube Q₉₄. Alternatively, one end of the first switching switch K₉₁ may be coupled to the emitter of the switch tube Q₉₅ and the collector of the switch tube Q₉₆.

The other end of the motor winding N_{U9}, the other end of the motor winding N_{V9}, and the motor winding N_{W9} are coupled to one end of the second switching switch K₉₂. The other end of the second switching switch K₉₂ and the other end of the first switching switch K₉₁ are coupled to the negative end of the direct current power supply 901.

Optionally, in some possible implementations, the powertrain further includes an inductor (not shown in the figure). A specific connection manner of the inductor may be that one end of the inductor is coupled to the other end of the second switching switch K₉₂ and the other end of the first switching switch K₉₁, and the other end of the inductor is coupled to the second end of the direct current power supply 901.

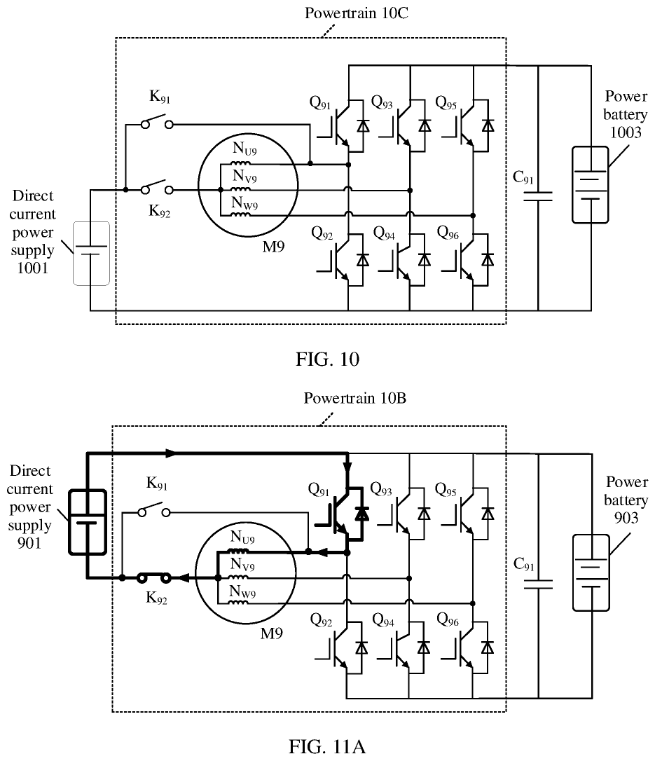

Optionally, in some possible implementations, FIG. 10 is a schematic diagram of another structure of a powertrain according to an embodiment. As shown in FIG. 10, a powertrain 10C is disposed between a direct current power supply 1001 and a power battery 1003. An internal structure of the powertrain 10C may refer to the powertrain 10B shown in FIG. 9. That is, the emitter of the switch tube Q₉₁ and the collector of the switch tube Q₉₂ are coupled to one end of the motor winding N_{U9}, the emitter of the switch tube Q₉₃ and the collector of the switch tube Q₉₄ are coupled to one end of the motor winding N_{V9}, and the emitter of the switch tube Q₉₅ and the collector of the switch tube Q₉₆ are coupled to one end of the motor winding N_{W9}. The other end of the motor winding N_{U9}, the other end of the motor winding N_{V9}, and the motor winding N_{W9} are coupled to one end of the second switching switch K₉₂, and one end of the first switching switch K₉₁ is coupled to the emitter of the switch tube Q₉₁ and the collector of the switch tube Q₉₂.

Compared to the powertrain 10B shown in FIG. 9, the powertrain 10C have a different manner of coupling the direct current power supply 1001 outward. In this case, in FIG. a first end of the direct current power supply 1001 is a negative end, and a second end of the direct current power supply 1001 is a positive end. A first end of the power battery 1003 is a negative end, and a second end of the power battery 1003 is a positive end.

That is, the positive end of the direct current power supply 1001 is coupled to the other end of the second switching switch K₉₂ and the other end of the first switching switch K₉₁, and the negative end of the direct current power supply 1001 is coupled to the collector of the switch tube Q₉₂, the collector of the switch tube Q₉₄, the collector of the switch tube Q₉₆, and the positive end of the power battery 1003. The positive end of the power battery 1003 is coupled to the collector of the switch tube Q₉₁, the collector of the switch tube Q₉₃, and the collector of the switch tube Q₉₅.

The powertrain 10B shown in FIG. 9 is used as an example below to describe a circuit status of the powertrain.

For example, the controller controls the second switching switch K₉₂ to be turned on, and the controller sends a signal to each bridge arm based on the waveform shown in FIG. 6. That is, the controller may send the [symbol] signal to the switch tube Q₃₁, send the [symbol] signal to the switch tube Q₃₃, and send the [symbol] signal to the switch tube Q₃₅.

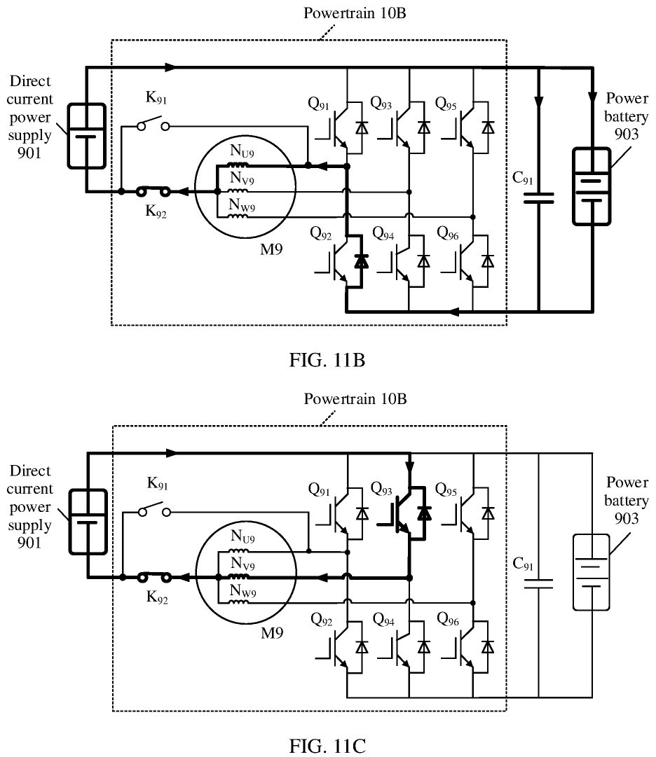

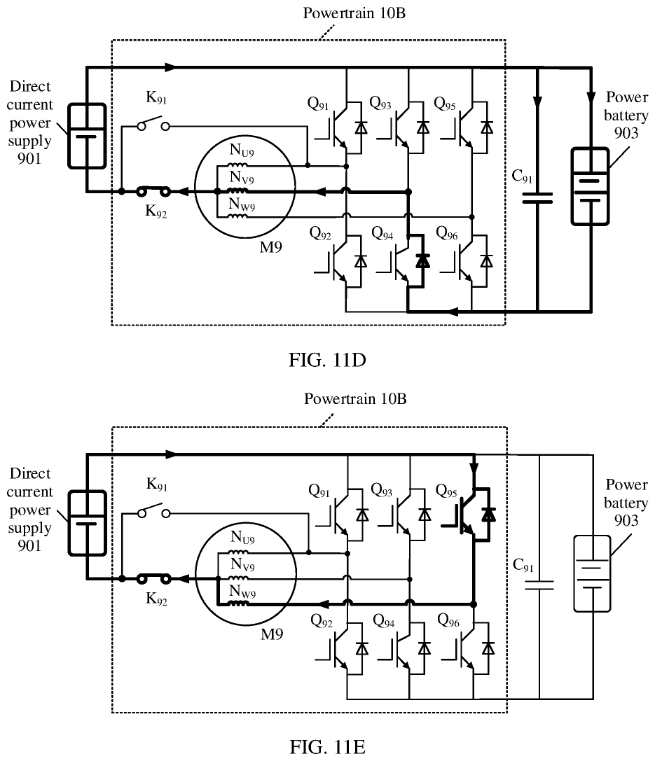

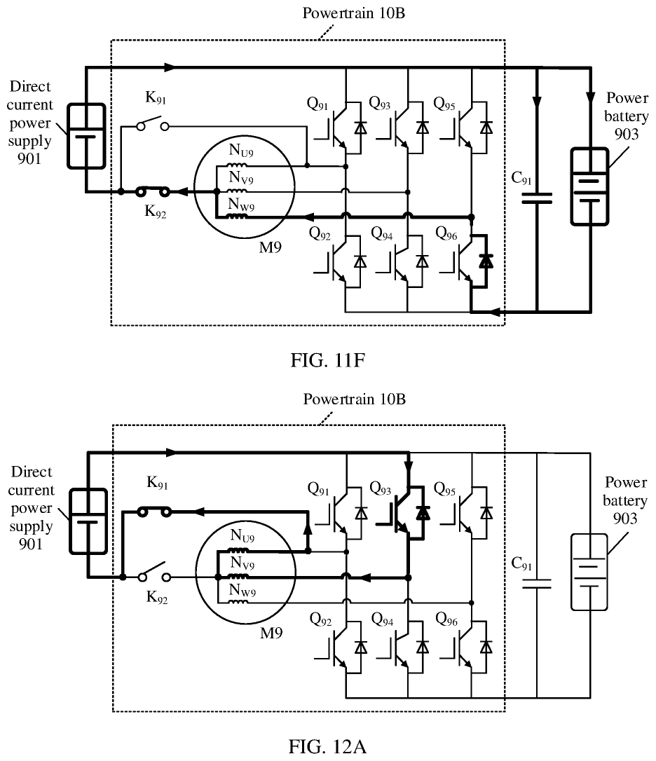

Therefore, in a time period between the t₆₁ moment and the t₆₂ moment, the switch tube Q₉₁ is turned on, the switch tube Q₉₃ and the switch tube Q₉₅ are turned on, and the second switching switch K₉₂ is turned on. In this case, the powertrain 10B forms a circuit status shown in FIG. 11A. The direct current power supply 901 charges the motor winding Nu 9 through the switch tube Q₉₁.

In a time period between the t₆₂ moment and the t₆₃ moment, the switch tube Q₉₁, the switch tube Q₉₃, and the switch tube Q₉₅ are turned off, and the second switching switch K₉₂ is turned on. In this case, the powertrain 10B forms a circuit status shown in FIG. 11B. The direct current power supply 901 and the motor winding N_{U9} are discharged jointly, and a voltage of two ends of the power battery 903 is a sum of a voltage of the direct current power supply 901 and a voltage of the motor winding N_{U9}, thereby increasing the voltage of the direct current power supply 901, and further providing the increased voltage to the power battery 903.

In a time period between the t₆₃ moment and the t₆₄ moment, the switch tube Q₉₃ is turned on, the switch tube Q₉₁ and the switch tube Q₉₅ are turned off, and the second switching switch K₉₂ is turned on. In this case, the powertrain 10B forms a circuit status shown in FIG. 11C. The direct current power supply 901 charges the motor winding N_{V9} through the switch tube Q₉₃.

In a time period between the t₆₄ moment and the t₆₅ moment, the switch tube Q₉₁, the switch tube Q₉₃, and the switch tube Q₉₅ are turned off, and the second switching switch K₉₂ is turned on. In this case, the powertrain 10B forms a circuit status shown in FIG. 11D. The direct current power supply 901 and the motor winding N_{V9} are discharged jointly, and a voltage of two ends of the power battery 903 is a sum of a voltage of the direct current power supply 901 and a voltage of the motor winding N_{V9}, thereby increasing the voltage of the direct current power supply 901, and further providing the increased voltage to the power battery 903.

In a time period between the t₆₅ moment and the t₆₆ moment, the switch tube Q₉₅ is turned on, the switch tube Q₉₁ and the switch tube Q₉₃ are turned off, and the second switching switch K₉₂ is turned on. In this case, the powertrain 10B forms a circuit status shown in FIG. 11E. The direct current power supply 901 charges the motor winding N_{W9} through the switch tube Q₉₅.

In a time period between the t₆₆ moment and the t₆₉ moment, the switch tube Q₉₁, the switch tube Q₉₃, and the switch tube Q₉₅ are turned off, and the second switching switch K₉₂ is turned on. In this case, the powertrain 10B forms a circuit status shown in FIG. 11F. The direct current power supply 901 and the motor winding N_{W9} are discharged jointly, and a voltage of two ends of the power battery 903 is a sum of a voltage of the direct current power supply 901 and a voltage of the motor winding N_{W9}, thereby increasing the voltage of the direct current power supply 901, and further providing the increased voltage to the power battery 903.

FIG. 11A to FIG. 11F are all circuit statuses that can be formed by the powertrain 10B in a case in which the second switching switch K₉₂ is turned on and the first switching switch K₉₁ is turned off.

In some possible implementations, when a difference between a voltage of the power battery 903 and a voltage of the direct current power supply 901 is less than a first preset threshold, the first switching switch K₉₁ is turned off, and the second switching switch K₉₂ is turned on. The first preset threshold is an experienced value, such as 100 V or 150 V.

For example, before sending a PWM signal to each switch tube, the controller detects the voltage of the direct current power supply 901 and the voltage of the power battery 903. For example, when the controller detects that the voltage of the direct current power supply 901 is 500 V, the voltage of the power battery 903 is 600 V, and the first preset threshold is 150 V, the controller controls the first switching switch K₉₁ to be turned off, and the second switching switch K₉₂ to be turned on. In another example, after the controller sends a PWM signal to each switch tube, the power battery 903 is in a charging status, and the controller still detects the voltage of the power battery 903 in real time during charging. For example, before the voltage of the power battery 903 is charged from 600 V to 950 V, and when a difference between the voltage of the power battery 903 and the voltage of the direct current power supply 901 is less than the first preset threshold, the controller continues to control the first switching switch K₉₁ to be turned off, and the second switching switch K₉₂ to be turned on.

After the voltage of the power battery 903 is greater than or equal to 950 V, the controller controls the first switching switch K₉₁ to be turned on, and the second switching switch K₉₂ to be turned off.

Optionally, in some possible implementations, when a difference between a voltage of the power battery 903 and a voltage of the direct current power supply 901 is greater than or equal to a first preset threshold, the first switching switch K₉₁ is turned on, and the second switching switch K₉₂ is turned off. In this case, the controller may send a fourth PWM signal to the switch tube Q₉₃, and send a fifth PWM signal to the switch tube Q₉₅. In addition, the switch tube Q₉₁ is in a turn-off status. It may be understood that the controller may send a voltage in low level to the switch tube Q₉₁, to enable the switch tube Q₉₁ to be turned off. Alternatively, the controller does not control the switch tube Q₉₁, and a default status of the switch tube Q₉₁ is a turn-off status.

It should be noted that the fourth PWM signal and the fifth PWM signal may be synchronized signals, or rising edges or falling edges of the two signals may be interleaved. The fourth PWM signal and the fifth PWM signal are not limited in this embodiment.

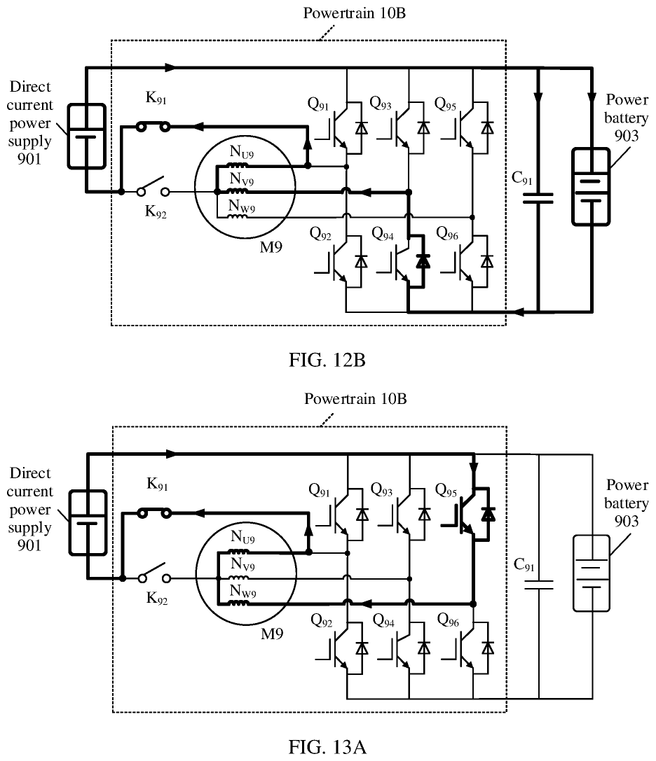

In this case, the powertrain 10B may have a plurality of circuit statuses. For example, the switch tube Q₉₃ is turned on, the switch tube Q₉₅ is turned off, and the first switching switch K₉₁ is turned on. In this case, the powertrain 10B may form a circuit status shown in FIG. 12A. The direct current power supply 901 charges the motor winding N_{V9} and the motor winding N_{U9} through the switch tube Q₉₃.

The switch tube Q₉₃ and the switch tube Q₉₅ are turned off, and the first switching switch K₉₁ is turned on. In this case, the powertrain 10B may form a circuit status shown in FIG. 12B. The direct current power supply 901, the motor winding N_{V9}, and the motor winding N_{U9} are discharged jointly, and a voltage of two ends of the power battery 903 is a sum of a voltage of the direct current power supply 901 and voltages of the motor winding N_{U9} and the motor winding N_{V9}, thereby increasing the voltage of the direct current power supply 901, and further providing the increased voltage to the power battery 903.

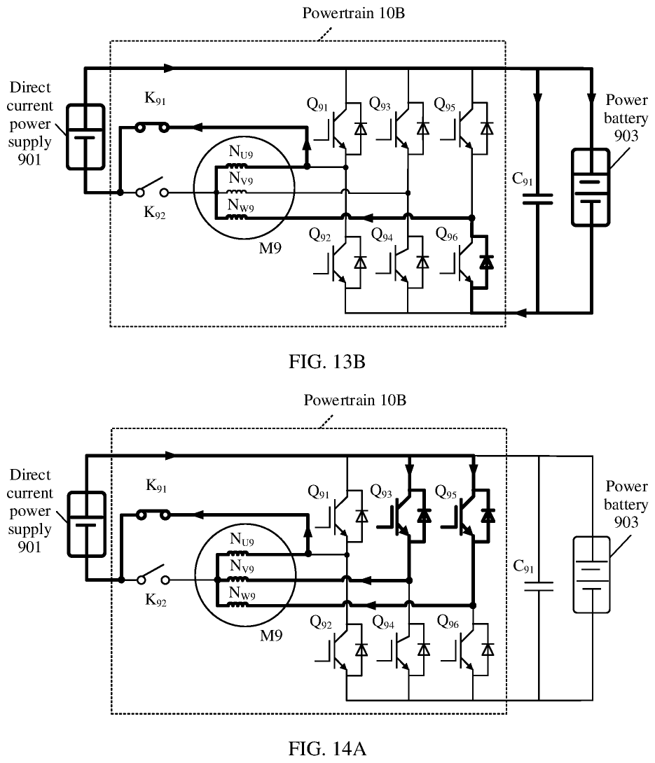

In another example, the switch tube Q₉₅ is turned on, the switch tube Q₉₃ is turned off, and the first switching switch K₉₁ is turned on. In this case, the powertrain 10B may form a circuit status shown in FIG. 13A. The direct current power supply 901 charges the motor winding N_{W9} and the motor winding N_{U9} through the switch tube Q₉₅.

The switch tube Q₉₃ and the switch tube Q₉₅ are turned off, and the first switching switch K₉₁ is turned on. In this case, the powertrain 10B may form a circuit status shown in FIG. 13B. The direct current power supply 901, the motor winding N_{W9}, and the motor winding N_{U9} are discharged jointly, and a voltage of two ends of the power battery 903 is a sum of a voltage of the direct current power supply 901 and voltages of the motor winding N_{U9} and the motor winding N_{W9}, thereby increasing the voltage of the direct current power supply 901, and further providing the increased voltage to the power battery 903.

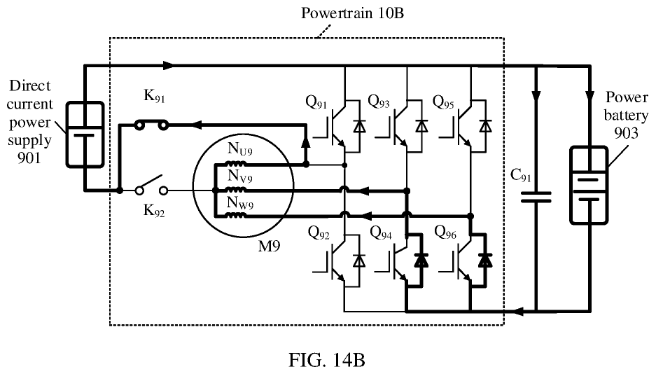

In another example, the switch tube Q₉₃ and the switch tube Q₉₅ are turned on, and the first switching switch K₉₁ is turned on. In this case, the powertrain 10B may form a circuit status shown in FIG. 14A. The direct current power supply 901 charges the motor winding N_{V9} and the motor winding N_{U9} through the switch tube Q₉₃, and the direct current power supply 901 further charges the motor winding N_{W9} and the motor winding N_{U9} through the switch tube Q₉₅. The switch tube Q₉₃ and the switch tube Q₉₅ are turned on, and the first switching switch K₉₁ is turned on. In this case, the powertrain 10B may form a circuit status shown in FIG. 14B. The direct current power supply 901, the motor winding N_{U9}, and the motor winding N_{V9} are discharged jointly, and the direct current power supply 901, the motor winding N_{U9}, and the motor winding N_{W9} are discharged jointly. In this case, a sum of a voltage of two ends when the motor winding N_{V9} and the motor winding N_{W9} are connected in parallel, a voltage of two ends of the motor winding N_{U9}, and a voltage of two ends of the direct current power supply 901 is a voltage of two ends of the power battery 903.

It should be noted that the terms “first” and “second” are merely intended for a purpose of description, and shall not be understood as an indication or implication of relative importance.

The foregoing descriptions are merely implementations of the embodiments, but are not intended as limiting. Any variation or replacement readily figured out by a person skilled in the art shall fall within the scope of the embodiments.

1. A powertrain, wherein the powertrain is disposed between a direct current power supply and a power battery, the powertrain comprising:
a motor control unit (MCU) and a motor, the MCU comprises three bridge arms and a controller, and the motor comprises three motor windings corresponding to the three bridge arms;
a first end of the direct current power supply is coupled to one end of each of the three bridge arms and a first end of the power battery, a second end of the power battery is coupled to the other end of each bridge arm, a midpoint of each bridge arm is coupled to one end of a motor winding corresponding to each bridge arm, and another end of each of the three motor windings is coupled to a second end of the direct current power supply; and
the three bridge arms comprise a first bridge arm and a second bridge arm, the first bridge arm is turned on or off based on a first pulse width modulation (PWM) signal sent by the controller, and the second bridge arm is turned on or off based on a second PWM signal sent by the controller; and a rising edge of the second PWM signal lags behind a first preset time period relative to a rising edge of the first PWM signal, or a falling edge of the second PWM signal lags behind a second preset time period relative to a falling edge of the first PWM signal.

2. The powertrain according to claim 1, wherein the three bridge arms further comprise a third bridge arm, and the third bridge arm is turned on or off based on a third PWM signal; and
a rising edge of the third PWM signal lags behind a third preset time period relative to the rising edge of the second PWM signal, or a falling edge of the third PWM signal lags behind a fourth preset time period relative to the falling edge of the second PWM signal.

3. The powertrain according to claim 2, wherein a time period of the first PWM signal is T, and the first preset time period and the third preset time period are T/3, or the second preset time period and the fourth preset time period are T/3.

4. The powertrain according to claim 1, wherein the three bridge arms further comprise a third bridge arm, and the third bridge arm is turned on or off based on a third PWM signal; and
a rising edge of the third PWM signal and the rising edge of the first PWM signal appear simultaneously, and a falling edge of the third PWM signal and the falling edge of the first PWM signal appear simultaneously.

5. The powertrain according to claim 4, wherein a time period of the first PWM signal is T, and the first preset time period is T/2, or the second preset time period is T/2.

6. The powertrain according to claim 2, wherein the first PWM signal, the second PWM signal, and the third PWM signal have a same time period and duty ratio.

7. The powertrain according to claim 1, further comprising a first switching switch and a second switching switch, wherein
one end of the first switching switch is coupled to a midpoint of any of the three bridge arms; and
the other end of each of the three motor windings being coupled to a second end of the direct current power supply comprises:
the other end of each of the three motor windings is coupled to one end of the second switching switch, and the other end of the second switching switch and the other end of the first switching switch are coupled to the second end of the direct current power supply.

8. The powertrain according to claim 7, wherein when a difference between a voltage of the power battery and a voltage of the direct current power supply is less than a first preset threshold, the first switching switch is turned off, and the second switching switch is turned on.

9. The powertrain according to claim 7, wherein when a difference between a voltage of the power battery and a voltage of the direct current power supply is greater than or equal to a first preset threshold, the first switching switch is turned on, and the second switching switch is turned off; and
that the first bridge arm is turned on or off based on a first PWM signal, and the second bridge arm is turned on or off based on a second PWM signal comprises:
other two bridge arms in the three bridge arms other than the any one of the three bridge arms are respectively turned on or off based on a fourth PWM signal and a fifth PWM signal.

10. The powertrain according to claim 7, further comprising an inductor, wherein
the other end of the second switching switch and the other end of the first switching switch being coupled to the second end of the direct current power supply comprises:
the other end of the second switching switch and the other end of the first switching switch are coupled to one end of the inductor, and the other end of the inductor is coupled to the second end of the direct current power supply.

11. A charging control method, wherein the charging control method is applied to a powertrain, the powertrain comprises a motor control unit (MCU) and a motor, the MCU comprises three bridge arms and a controller, and the motor comprises three motor windings corresponding to the three bridge arms;
a first end of the direct current power supply is coupled to one end of each of the three bridge arms and a first end of a power battery, a second end of the power battery is coupled to the other end of each bridge arm, a midpoint of each bridge arm is coupled to one end of a motor winding corresponding to each bridge arm, another end of each of the three motor windings is coupled to a second end of the direct current power supply, and the three bridge arms comprise a first bridge arm and a second bridge arm; and
the charging control method comprises:
sending, by the controller, a first pulse width modulation (PWM) signal to the first bridge arm, and sending a second PWM signal to the second bridge arm, wherein a rising edge of the second PWM signal lags behind a first preset time period relative to a rising edge of the first PWM signal, or a falling edge of the second PWM signal lags behind a second preset time period relative to a falling edge of the first PWM signal.

12. The charging control method according to claim 11, wherein the three bridge arms further comprise a third bridge arm; and
the charging control method further comprises:
sending, by the controller, a third PWM signal to the third bridge arm, wherein a rising edge of the third PWM signal lags behind a third preset time period relative to the rising edge of the second PWM signal, or a falling edge of the third PWM signal lags behind a fourth preset time period relative to the falling edge of the second PWM signal.

13. The charging control method according to claim 12, wherein a time period of the first PWM signal is T, and the first preset time period and the third preset time period are T/3, or the second preset time period and the fourth preset time period are T/3.

14. The charging control method according to claim 11, wherein the three bridge arms further comprise a third bridge arm; and
the charging control method further comprises:
sending, by the controller, a third PWM signal to the third bridge arm, wherein a rising edge of the third PWM signal and the rising edge of the first PWM signal appear simultaneously, and a falling edge of the third PWM signal and the falling edge of the first PWM signal appear simultaneously.

15. The charging control method according to claim 14, wherein a time period of the first PWM signal is T, and the first preset time period is T/2, or the second preset time period is T/2.

16. An electric vehicle, comprising:
a power battery and a powertrain, wherein the powertrain is disposed between a direct current power supply and the power battery, the powertrain comprises a motor control unit (MCU) and a motor, the MCU comprises three bridge arms and a controller, and the motor comprises three motor windings corresponding to the three bridge arms;
a first end of the direct current power supply is coupled to one end of each of the three bridge arms and a first end of the power battery, a second end of the power battery is coupled to the other end of each bridge arm, a midpoint of each bridge arm is coupled to one end of a motor winding corresponding to each bridge arm, and another end of each of the three motor windings is coupled to a second end of the direct current power supply; and
the three bridge arms comprise a first bridge arm and a second bridge arm, the first bridge arm is turned on or off based on a first pulse width modulation (PWM) signal sent by the controller, and the second bridge arm is turned on or off based on a second PWM signal sent by the controller; and a rising edge of the second PWM signal lags behind a first preset time period relative to a rising edge of the first PWM signal, or a falling edge of the second PWM signal lags behind a second preset time period relative to a falling edge of the first PWM signal.

17. The electric vehicle according to claim 16, wherein the three bridge arms further comprise a third bridge arm, and the third bridge arm is turned on or off based on a third PWM signal; and
a rising edge of the third PWM signal lags behind a third preset time period relative to the rising edge of the second PWM signal, or a falling edge of the third PWM signal lags behind a fourth preset time period relative to the falling edge of the second PWM signal.

18. The electric vehicle according to claim 17, wherein a time period of the first PWM signal is T, and the first preset time period and the third preset time period are T/3, or the second preset time period and the fourth preset time period are T/3.

19. The electric vehicle according to claim 16, wherein the three bridge arms further comprise a third bridge arm, and the third bridge arm is turned on or off based on a third PWM signal; and
a rising edge of the third PWM signal and the rising edge of the first PWM signal appear simultaneously; and a falling edge of the third PWM signal and the falling edge of the first PWM signal appear simultaneously.

20. The electric vehicle according to claim 19, wherein a time period of the first PWM signal is T, and the first preset time period is T/2, or the second preset time period is T/2.
